(19) United States
(12) Patent Application Publication
(10) Pub. No.: US 2010/0235269 A1
(43) Pub. Date: Sep. 16, 2010

(54) System and Method of Processing Asset Data

(75) Inventors: Rafael Munoz, Lemont, IL (US); Arthur Fung, Addison, IL (US); Barton D. Johnson, Rockford, IL (US)

Correspondence Address: AT&T Legal Department - LNA;Attn: Patent Docketing, Room 2A- 207, One AT & T Way, Bedminster, NJ, 07921, US

(73) Assignee: AT&T INTELLECTUAL PROPERTY I, L.P., Reno, NV (US)

(21) Appl. No.: 12/401,910

(22) Filed: Mar. 11, 2009

(51) Int. Cl. G06Q 40/00; G06F 17/30

(52) U.S. Cl. 705/31; 707/E17.014; 707/E17.044

(57) ABSTRACT

A method of processing asset data can include receiving data related to an asset from an electronic data warehouse at an adjustment system. The method can also include identifying a tax class of a plurality of tax classes based on the received data and storing the received data in association with the identified tax class. Further, the method can include determining based on the received data that the asset has been added, retired or depreciated during a time period. In addition, the method can include adjusting a value of the asset, wherein the adjusted value corresponds to an addition, retirement or depreciation of the asset.

### FIELD OF THE DISCLOSURE

The present disclosure generally relates to methods of processing asset data.

### BACKGROUND

As a business enterprise grows, it acquires a greater number of assets. The values of some assets can be adjusted for tax purposes or other financial purposes. For example, the business enterprise may be able to deduct depreciation of some assets from their tax liabilities.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating a particular embodiment of a system to process asset data;

FIG. 2 is a block diagram illustrating a particular embodiment of a method of processing asset data;

FIG. 3 is a block diagram illustrating another particular embodiment of a method of processing asset data; and

FIGS. 4-15 are diagrams illustrating particular embodiments of graphical user interfaces to process asset data.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed systems, methods or computer-readable media. Moreover, some statements may apply to some inventive features but not to others.

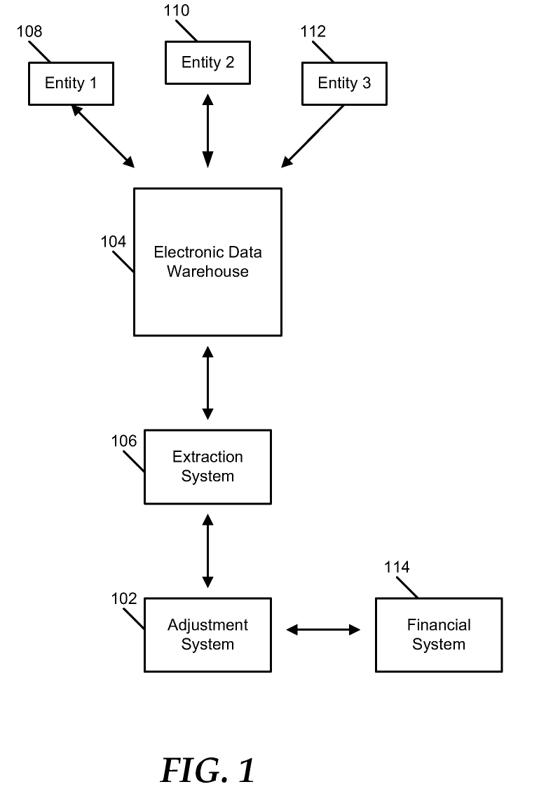

FIG. 1 illustrates a particular embodiment of a system to process asset data. The system includes an adjustment system 102 that communicates with an electronic data warehouse (EDW) 104. In one embodiment, the adjustment system 102 can communicate with the EDW 104 via an extraction system 106. The adjustment system 102 can also communicate with a financial system 114. The EDW 104 can communicate with a plurality of entity systems 108, 110 and 112 associated with a plurality of taxable entities, business units or divisions, or other entities.

In an illustrative embodiment, the EDW 104 includes a database and is adapted to receive data related to fixed assets and other assets from each of the entity systems 108, 110 and 112. The data can include, for example, an asset name, an asset value, an in-service year, a business entity associated with the asset, other asset data, or any combination thereof. The data received from each entity can have a corresponding format that differs from the format of data received from another entity.

Examples of assets or asset types for which the EDW 104 can receive and store data include land, a motor vehicle, a building, a digital switch, an aircraft, equipment, tools, an office supply, furniture, a computer, a radio system, an analog circuit, a digital circuit, a property improvement, a property fixture, an operator system, public telephone equipment, a telephone pole, an aerial cable, an underground cable, a buried cable, an intra-building cable, an HVAC system, a copper line, a fiber line, a Digital Subscriber Line Access Multiplexer, a cellular tower, another asset or asset type, any combination thereof.

The adjustment system 102 can include a computing system, software program, or any combination thereof, that is adapted to receive a command from a user to extract data from the EDW 104 related to an asset, a type of asset, or a category of asset data. The request can also include a time period, such as a calendar year, fiscal year, quarter, or other time period; a business entity identifier; other information; or any combination thereof.

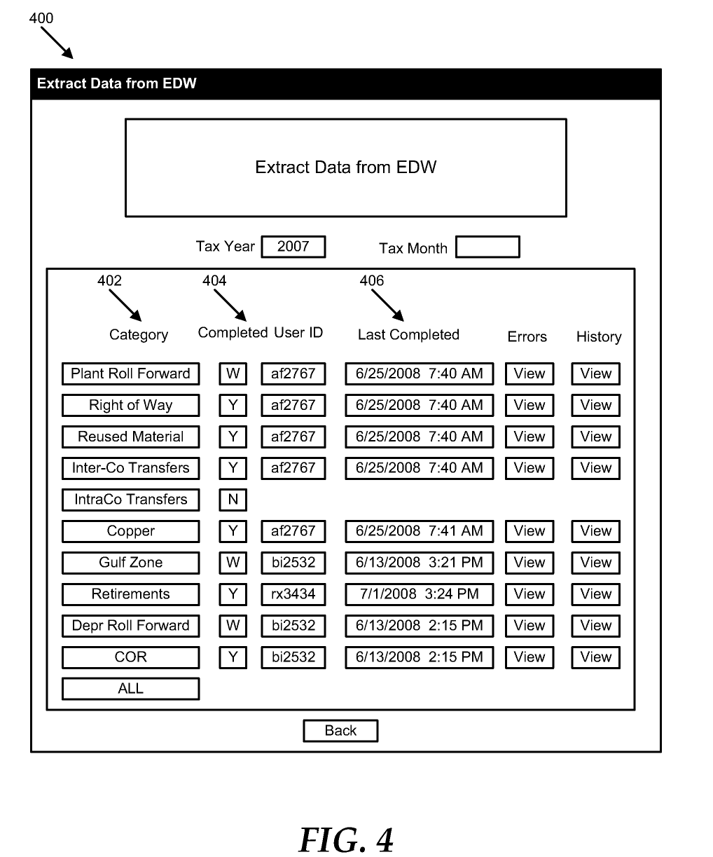

In one embodiment, the adjustment system 102 can be adapted to receive the request via a graphical user interface (GUI), such as the GUI 400 illustrated in FIG. 4, which includes a plurality of selectable indicators 402 of asset data categories. For instance, the GUI 400 can include selectable indicators 402 of a plant roll forward category, a right of way category, a reused material category, an inter-company transfer category, an intra-company transfer category, a copper line category, a fiber line category, a gulf zone category, a retirements category, a depreciation roll forward category, a cost of removal category, another category, or any combination thereof. An indicator 402 can be selectable to request data related to assets falling under the corresponding category.

In response to a command to extract data, the adjustment system 102 can be adapted to send an instruction to the extraction system 106 to extract data related to the requested asset, asset type, asset data category, the time period, the business entity, or any combination thereof, from the EDW 104. The extraction system 106 can include a computing system, software program, or any combination thereof, that is physically separate, logically separate, or any combination thereof, from the adjustment system 102 and that is adapted to mine data stored at the EDW 104. In an illustrative embodiment, the GUI 400 can indicate at 404 whether the extraction was completed successfully (Y), completed with errors such as re-formatting errors (W), or not completed (N). The GUI 400 can also indicate at 406 when a most recent extraction related to the asset type was completed.

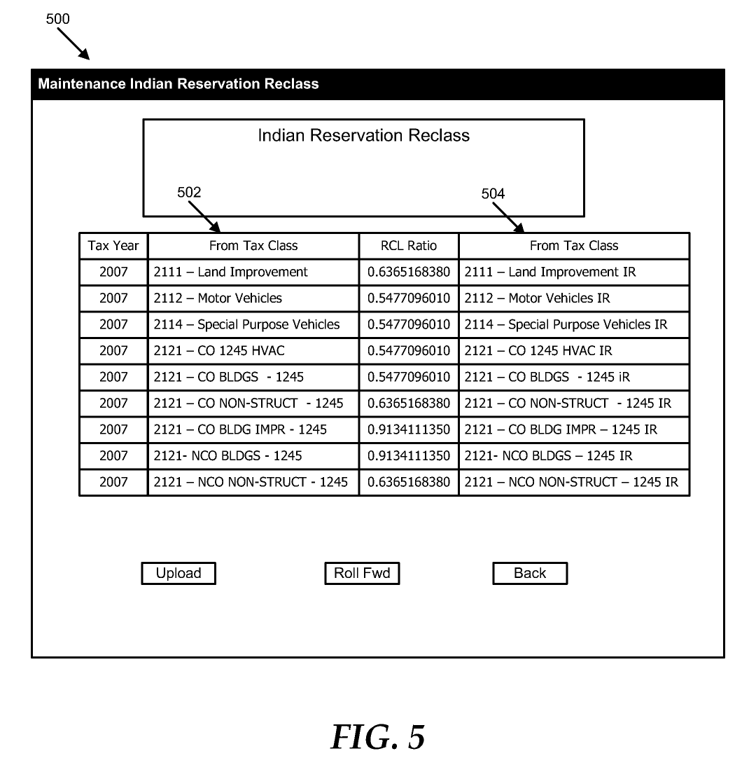

The adjustment system 102 is adapted to receive the extracted asset data from the EDW 104 via the extraction system 106. In one embodiment, the adjustment system 102 can be adapted to re-format the asset data into a format associated with the adjustment system 102, a format associated with the financial system 114, or another format. The adjustment system 102 can be adapted to determine an initial value of an asset for which data is received from the EDW 104. Further, the adjustment system 102 is adapted to identify a tax class from a plurality of tax classes based on the asset data extracted from the EDW 104. The adjustment system 102 is adapted to store the asset data, the initial value, or any combination thereof, in association with the identified tax class. A tax class can be identified by a number or other character string. The tax class can be pre-defined or user-defined. In a particular embodiment, the adjustment system 102 can be adapted to provide a GUI, such as the GUI 500 illustrated in FIG. 5, that enables manual reclassification of asset data, such as asset value data, from a class 502 to another class 504.

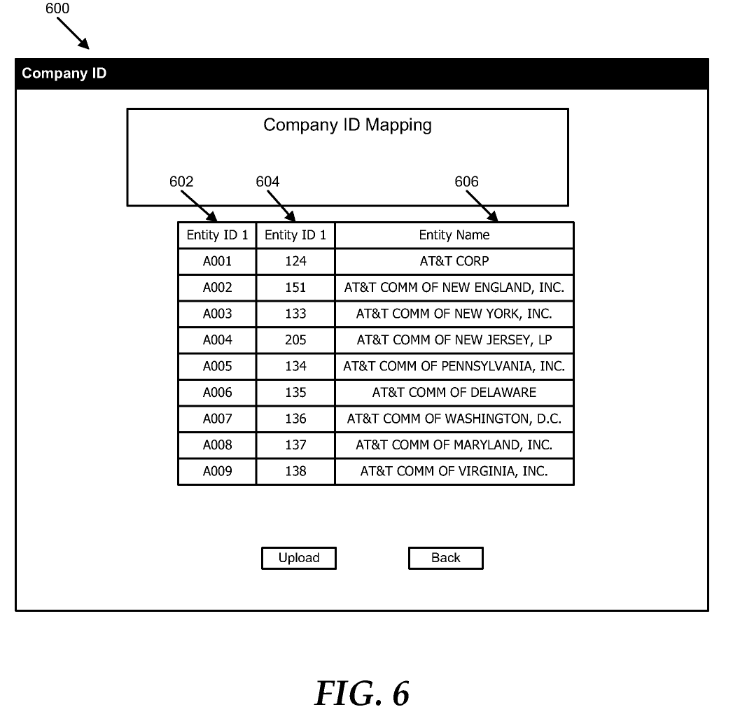

In a particular embodiment, the adjustment system 102 can also store the asset data, the initial value, or any combination thereof, in association with a business entity identifier, such as a taxable entity identifier, that includes a number, a name, another character string, or any combination thereof. The adjustment system 102 can be adapted to provide a GUI, such as the GUI 600 illustrated in FIG. 6, that enables a user to map an entity identifier 602 for a particular entity 606 to another entity identifier 604. For example, an entity identifier used by the EDW 104 for a particular entity can be mapped to another entity identifier used by the adjustment system 102, the financial system 114, another system, or any combination thereof.

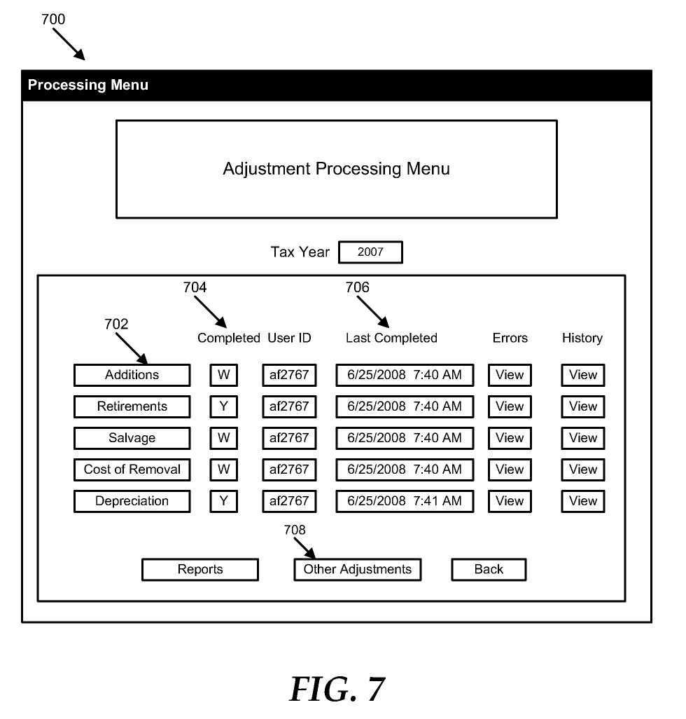

In addition, the adjustment system 102 is adapted to receive a command to adjust an initial value or other value of an asset, such as assets in a particular adjustment category. In a particular embodiment, the adjustment system 102 can be adapted to provide a GUI, such as the GUI 700 illustrated in FIG. 7, that includes a plurality of selectable indicators 702 of adjustment categories, such as additions, retirements, salvage, cost of removal (COR), depreciation, another adjustment category, or any combination thereof. An indicator 702 is selectable to instruct the adjustment system 102 to identify assets as added, retired or depreciated, for example, and to adjust the values (such as individual values, a total value, or any combination thereof) of the identified assets based on pre-defined rules corresponding to a tax regulation, an insurance rule, a regulatory agency rule, another rule, or any combination thereof. In an illustrative embodiment, the GUI 700 can indicate at 704 whether the adjustments for the category 702 was completed successfully (Y), completed with errors such as re-formatting errors (W), or not completed (N). The GUI 700 can also indicate at 706 when a most recent adjustment related to the category was completed.

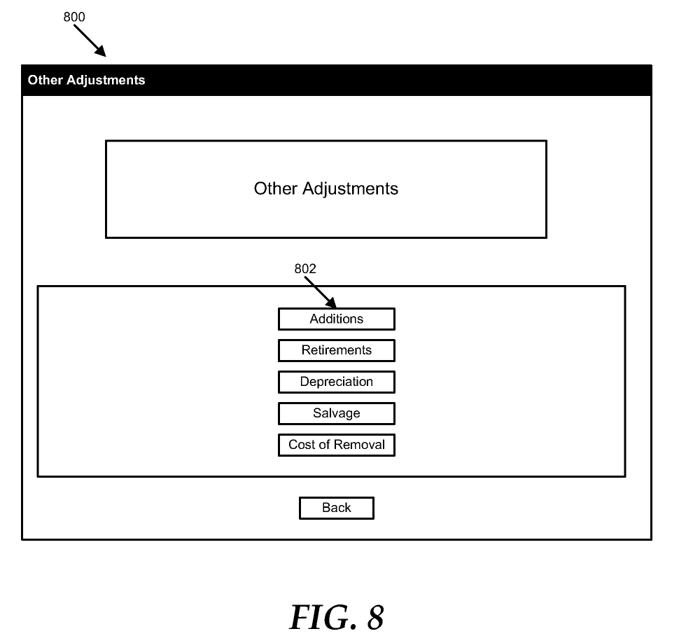

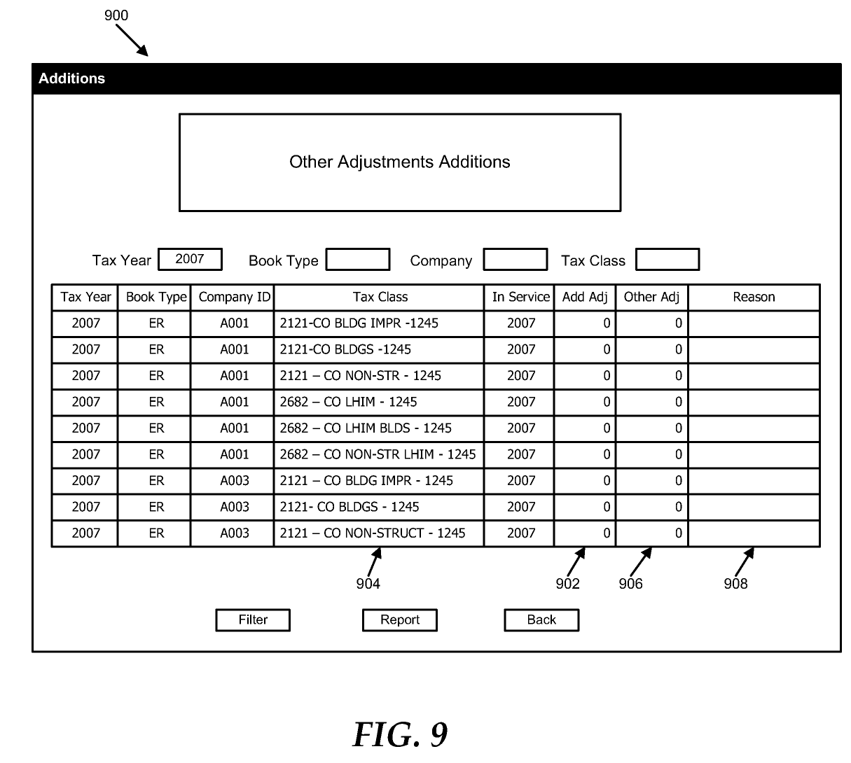

In addition, the GUI 700 can include a selectable indicator 708 that is selectable to enter other adjustments manually. For example, the indicator 708 can be selectable to access another GUI, such as the GUI 800 illustrated in FIG. 8 that includes a plurality of selectable indicators 802 to manually enter adjustments related to additions, retirements, depreciation, salvage, COR, another adjustment category, or any combination thereof. An indicator 802, such as the additions indicator, can be selectable to access a GUI, such as the GUI 900 illustrated in FIG. 9 that includes a field 902 indicating a current adjusted value of assets in a particular tax class 904. The GUI 900 also includes a field 906 in which another adjustment to the value in the field 902 can be entered. In addition, the GUI 900 includes a field 908 in which a reason for the other adjustment can be entered, such as for auditing purposes.

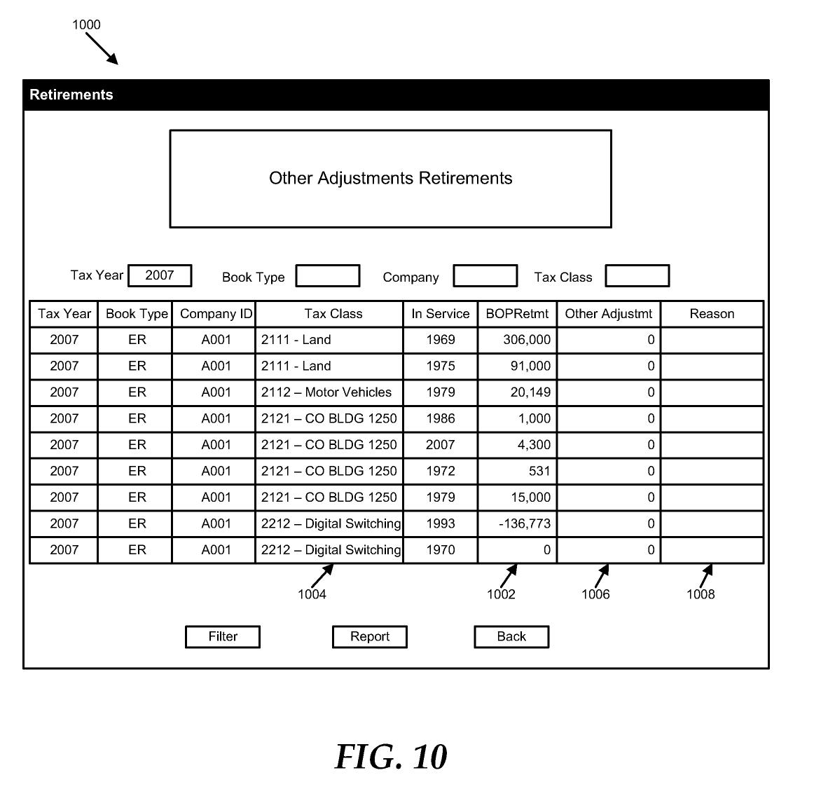

In another example, an indicator 802 in FIG. 8 can be selectable to access a GUI, such as the GUI 1000 illustrated in FIG. 10 that includes a field 1002 indicating a current adjusted value of assets in a particular tax class 1004, such as a beginning of period (BOP) retirement value. The GUI 1000 also includes a field 1006 in which another adjustment to the value in the field 1002 can be entered. In addition, the GUI 1000 includes a field 1008 in which a reason for the other adjustment can be entered, such as for auditing purposes.

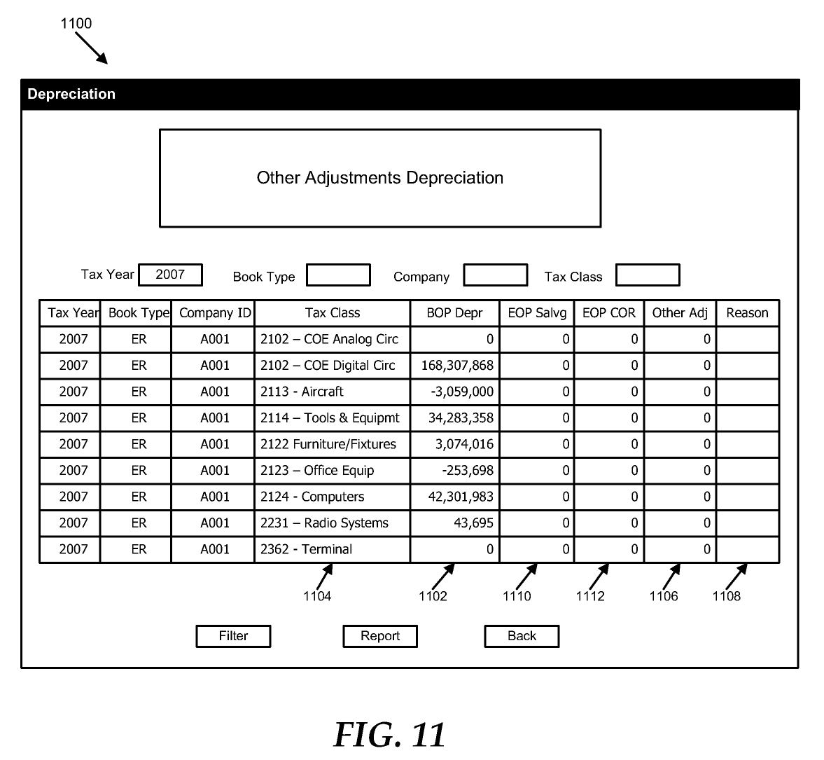

In a further example, an indicator 802 in FIG. 8 can be selectable to access a GUI, such as the GUI 1100 illustrated in FIG. 11 that includes a field 1102 indicating a current adjusted value of assets in a particular tax class 1104, such as a beginning of period (BOP) depreciation value. The GUI 1100 also includes a field 1106 in which another adjustment to the value in the field 1102 can be entered. In addition, the GUI 1100 includes a field 1108 in which a reason for the other adjustment can be entered, such as for auditing purposes. The GUI 1100 can also include fields 1110 and 1112 that include end of period (EOP) salvage and EOP COR values.

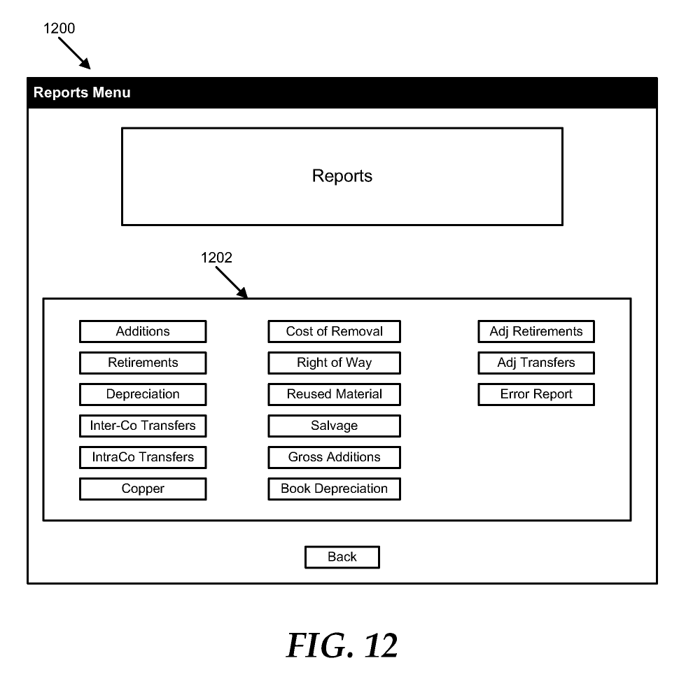

The adjustment system 102 is also adapted to receive a request for a report indicating adjusted values (including individual values, a total value, or any combination thereof) for assets included in an adjustment category, an asset data category, another reporting category, or any combination thereof. For instance, the adjustment system 102 can be adapted to provide a GUI, such as the GUI 1200 illustrated in FIG. 12 that includes a plurality of selectable indicators 1202 of reporting categories, such as additions, retirements, depreciation, inter-company transfers, intra-company transfers, copper lines, cost of removal, right of way, reused material, salvage, gross additions, book depreciation, adjusted retirements, adjusted transfers, errors, another reporting category, or any combination thereof.

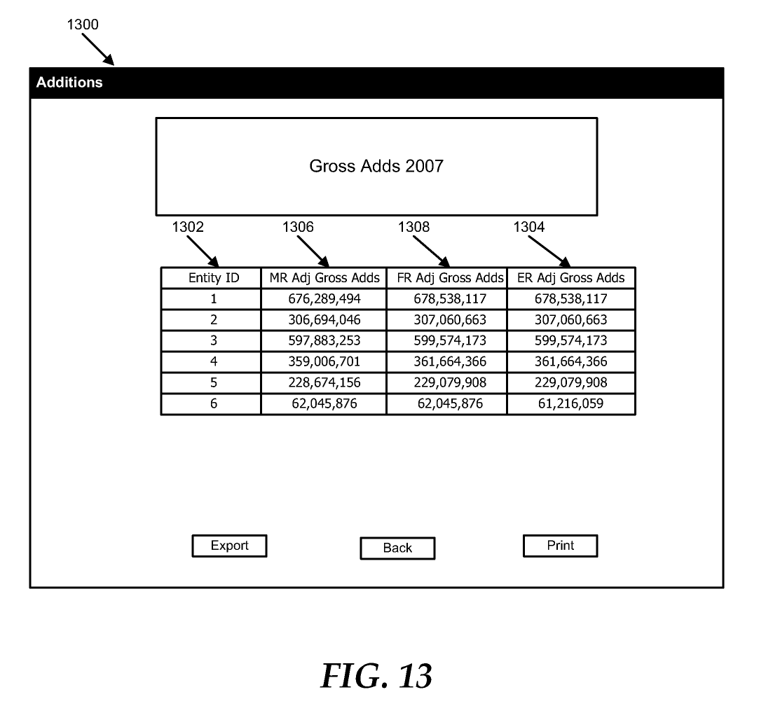

For example, an indicator 1202, such as a gross additions indicator, is selectable to cause the adjustment system 102 to output a report, such as the report 1300 illustrated in FIG. 13. The report 1300 can include adjusted gross values of added assets for a time period, such as a tax year, for a taxable entity, such as the plurality of taxable entities 1302. In one embodiment, the adjusted gross values can include values 1304 adjusted according to domestic tax regulations; values 1306 related adjusted to regulatory rules; values 1308 adjusted according to foreign tax regulations; other values, such as values adjusted according to insurance rules or values adjusted according to state tax regulations; or any combination thereof. As illustrated in FIG. 13, the GUI 1300 can include selectable indicators to print or export the displayed report. For example, the adjustment system 102 can receive a command via the GUI 1300 to export the report to the financial system 114.

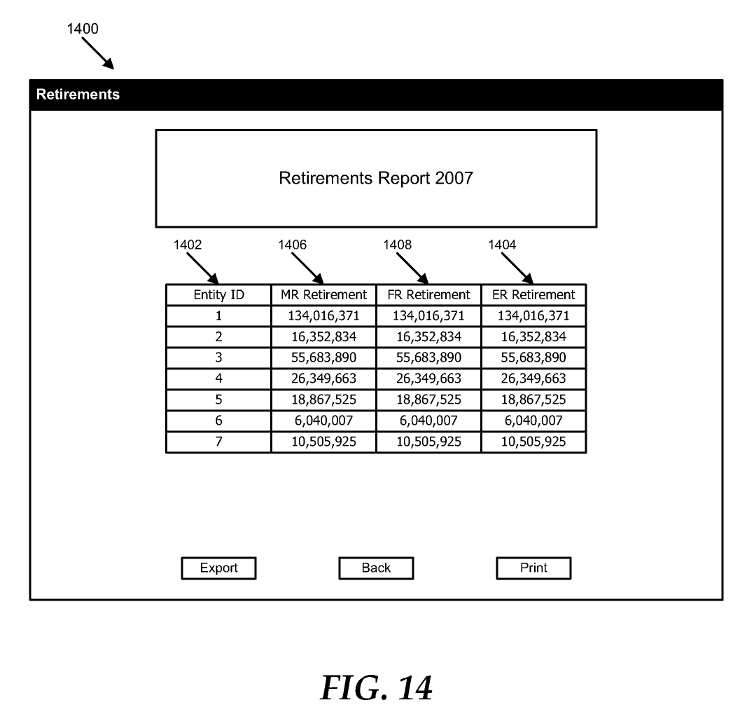

In another example, an indicator 1202, such as a retirements indicator, is selectable to cause the adjustment system 102 to output a report, such as the report 1400 illustrated in FIG. 14. The report 1400 can include adjusted values of retired assets for a time period, such as a tax year, for a taxable entity, such as the plurality of taxable entities 1402. In one embodiment, the adjusted values can include values 1404 adjusted according to domestic tax regulations; values 1406 related adjusted to regulatory rules; values 1408 adjusted according to foreign tax regulations; other values, such as values adjusted according to insurance rules or values adjusted according to state tax regulations; or any combination thereof. As illustrated in FIG. 14, the GUI 1400 can include selectable indicators to print or export the displayed report.

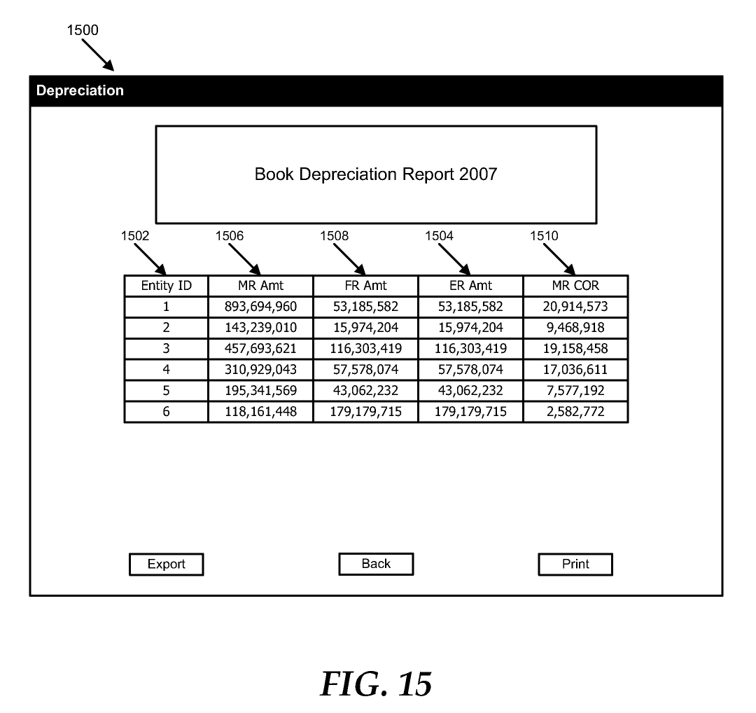

In another example, an indicator 1202, such as a book depreciation indicator, is selectable to cause the adjustment system 102 to output a report, such as the report 1500 illustrated in FIG. 15. The report 1500 can include adjusted values of depreciated assets for a time period, such as a tax year, for a taxable entity, such as the plurality of taxable entities 1502. In one embodiment, the adjusted values can include values 1504 adjusted according to domestic tax regulations; values 1506 related adjusted to regulatory rules; values 1508 adjusted according to foreign tax regulations; other values, such as values adjusted according to insurance rules or values adjusted according to state tax regulations; or any combination thereof. As illustrated in FIG. 15, the GUI 1500 can include selectable indicators to print or export the displayed report.

In a particular embodiment, the adjustment system 102 can be adapted to output asset data, reports, or any combination thereof, to the financial system 114. The financial system 114 can include a computing device, a software program, or any combination thereof, that is physically separate, logically separate, or any combination thereof, from the adjustment system 102.

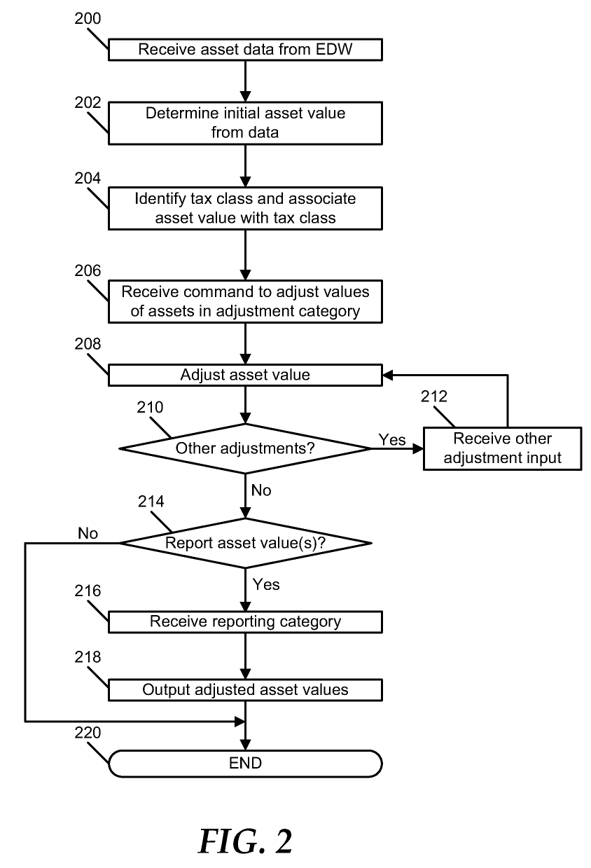

FIG. 2 illustrates a particular embodiment of a method of processing asset data. At block 200, an adjustment system receives extracted asset data from an EDW. Moving to block 202, the adjustment system determines an initial value associated with an asset for which data was received from the EDW. Proceeding to block 204, the adjustment system identifies a tax class based on the asset data received from the EDW and associates the asset data, the initial value, or any combination thereof, with the identified tax class.

Continuing to block 206, the adjustment system receives a command to adjust initial values or other values (such as individual values, a total value, or a combination thereof), for assets that have been added, retired, depreciated, or any combination thereof Advancing to block 208, the adjustment system adjusts the values of the assets according to a particular rule corresponding to a tax regulation, an insurance rule, a regulatory agency rule, another adjustment, or any combination thereof.

At decision node 210, the adjustment system determines whether it has received a request to input other adjustments. If the adjustment system has received such a request, the method moves to block 212, and the adjustment system receives input indicating other adjustments. The method then returns to block 208, and the adjustment system adjusts the values of assets for which other adjustments have been received.

Proceeding to decision node 214, the adjustment system determines whether it has received a request to output a report indicating an adjusted value for assets included in an adjustment category, an asset data category, another reporting category, or any combination thereof. If a reporting request is received, the method continues to block 216, and the adjustment system receives input indicating a reporting category. The method advances to block 218, and the adjustment system outputs adjusted asset values (including individual values, a total value, or any combination thereof) related to the requested reporting category. The method terminates at 220.

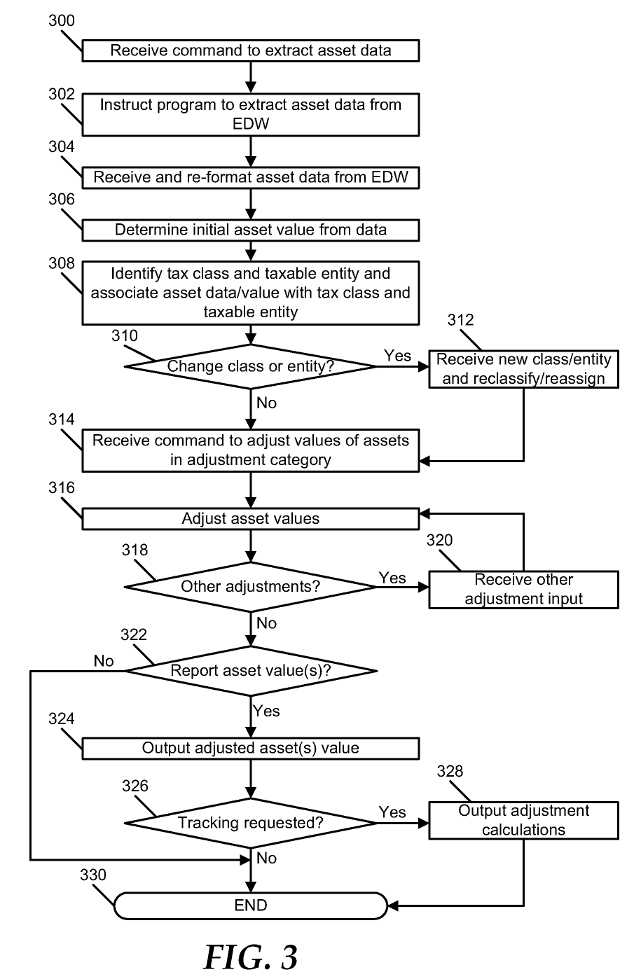

FIG. 3 illustrates another particular embodiment of a method of processing asset data. At block 300, an adjustment system receives a command to extract data related to an asset, a type of asset, or a category of asset data, from an EDW. The request can also include a time period, such as a calendar year, fiscal year, quarter, or other time period; a business entity identifier; other information; or any combination thereof. Moving to block 302, in a particular embodiment, the adjustment system can send an instruction to an extraction system, such as an extraction software program, to extract data related to the requested asset, asset type, asset data category, the time period, the business entity, or any combination thereof, from the EDW.

Proceeding to block 304, the adjustment system receives the extracted asset data from the EDW and reformats the asset data into a format associated with the adjustment system or another format. Continuing to block 306, the adjustment system determines an initial value associated with an asset for which data was received from the EDW. Advancing to block 308, the adjustment system identifies a tax class and taxable entity based on the asset data received from the EDW, and associates the asset data, the initial value, or any combination thereof, with the identified tax class and the identified taxable entity.

At decision node 310, the adjustment system determines whether it has received a request to change the tax class, taxable entity, or a combination thereof, with which data related to an asset is associated. If the adjustment system determines that it has received such a request, the method moves to block 312, and the adjustment receives input indicating a new tax class, a new taxable entity, or any combination thereof, and reclassifies the asset data, the initial value, or any combination thereof; reassigns the asset data, the initial value, or any combination thereof, to another taxable entity; or any combination thereof. Conversely, if the adjustment system does not receive a request to change the tax class, taxable entity, or a combination thereof, with which data related to an asset is associated, the method moves to block 314.

Moving to block 314, the adjustment system receives a command to adjust initial values or other values for assets that have been added, retired, salvaged, removed, depreciated, or any combination thereof. Proceeding to block 316, the adjustment system adjusts the values (such as individual values, a total value, or a combination thereof) of the assets according to a particular rule corresponding to a tax regulation, an insurance rule, a regulatory agency rule, another adjustment, or any combination thereof. Continuing to decision node 318, the adjustment system determines whether it has received a request to input other adjustments. If the adjustment system has received such a request, the method advances to block 320, and the adjustment system receives other adjustments. The method then returns to block 316, and the adjustment system adjusts the values of assets for which other adjustments have been received.

At decision node 322, the adjustment system determines whether it has received a request to output a report indicating adjusted values (such as individual values, a total value, or a combination thereof) for assets included in an adjustment category, an asset data category, another reporting category, or any combination thereof. If a reporting request is received, the method moves to block 324, and the adjustment system outputs adjusted asset values related to the requested reporting category. Proceeding to decision node 326, in a particular embodiment, the adjustment system can determine whether it has received a request to output tracking information related to an adjusted asset value, such as the adjusted asset values reported at block 324. If the adjustment system receives a tracking request, the method continues to block 328, and the adjustment system outputs calculations associated with the adjusted asset value for which the tracking request is received. The method terminates at 330.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the FIGs. are to be regarded as illustrative rather than restrictive.

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single device is described herein, more than one device may be used in place of a single device. Similarly, where more than one device is described herein, a single device may be substituted for that one device.

In the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A method of processing asset data, the method comprising:
receiving data related to an asset from an electronic data warehouse at an adjustment system;
identifying a tax class of a plurality of tax classes based on the received data;
storing the received data in association with the identified tax class;
determining based on the received data that the asset has been added, retired or depreciated during a time period; and
adjusting a value of the asset, wherein the adjusted value corresponds to an addition, retirement or depreciation of the asset.

2. The method of claim 1, further comprising instructing a system to retrieve the data related to the asset from the electronic data warehouse.

3. The method of claim 1, further comprising determining an initial value of the asset based on the received data, wherein the adjusted value of the asset includes an adjustment of the initial value.

4. The method of claim 3, further comprising storing the initial value in association with the identified tax class.

5. The method of claim 3, further comprising identifying an entity of a plurality of entities based on the received data and storing the received data, the initial value, or any combination thereof, in association with the identified entity.

6. The method of claim 5, further comprising receiving input from a user indicating another entity of the plurality of entities and storing the data in association with the other entity in response to the input.

7. The method of claim 1, further comprising re-formatting the received data from a format associated with the electronic data warehouse, an entity system communicating with the electronic data warehouse, a system adapted to extract data from the electronic data warehouse, or any combination thereof, to another format associated with the adjustment system, a financial system communicating with the adjustment system, or any combination thereof.

8. The method of claim 1, further comprising adjusting individual values, a total value, or any combination thereof, of a plurality of assets in an adjustment category, wherein the plurality of assets includes the asset.

9. The method of claim 1, further comprising receiving input from a user indicating another tax class of the plurality of tax classes and storing the data in association with the other tax class in response to the input.

10. The method of claim 1, further comprising receiving a request to extract data related to an asset data category from the EDW, wherein the asset is associated with the asset data category.

11. The method of claim 10, wherein the asset data category includes a plant roll forward category, a right of way category, a reused material category, an inter-company transfer category, an intra-company transfer category, a copper line category, a fiber line category, a gulf zone category, a retirements category, a depreciation roll forward category, a cost of removal category, or any combination thereof.

12. The method of claim 1, wherein the asset includes land, a motor vehicle, a special purpose vehicle, a building, an analog switch, a digital switch, an aircraft, equipment, an office supply, furniture, a computer, a radio system, an analog circuit, a digital circuit, terminal equipment, a property improvement, a fixture, an operator system, public telephone equipment, a telephone pole, an aerial cable, an underground cable, a buried cable, an intra-building cable, a heating ventilation air conditioning (HVAC) system, a digital subscriber line access multiplexer (DSLAM), a cellular tower, or any combination thereof.

13. The method of claim 1, wherein the data includes a time indicator related to the asset, the time including an in-service year, an out-of-service year, or a combination thereof, and wherein the asset is identified as an addition, a retirement or a depreciated asset based on the time indicator.

14. The method of claim 1, further comprising receiving input indicating another adjustment to the value of the asset and re-adjusting the value of the asset based on the other adjustment.

15. A computer-readable medium including processor-readable instructions that are executable by a processor to perform a method, the method comprising:
receiving data related to an asset;
identifying a tax class of a plurality of tax classes based on the received data;
determining an initial value of the asset based on the received data;
storing the received data, the initial value, or any combination thereof, in association with the identified tax class;
determining based on the received data that the asset corresponds to an adjustment type of a plurality of adjustment types during a time period; and
adjusting the initial value of the asset based on the adjustment type.

16. The computer-readable medium of claim 15, wherein the method further comprises providing a graphical user interface including a plurality of selectable indicators of asset data categories and receiving a request to extract data related to a selected asset data category via the graphical user interface, wherein the asset is associated with the asset data category.

17. The computer-readable medium of claim 15, wherein the method further comprises selecting an adjustment rule related to a federal tax authority, a regulatory authority, a federal tax authority, insurance, or a state tax authority, and wherein the adjusted value is determined according to the adjustment rule.

18. The computer-readable medium of claim 15, wherein the plurality of adjustment types include addition, retirement, salvage, cost of removal, depreciation or any combination thereof.

19. The computer-readable medium of claim 15, wherein the method further includes outputting the adjusted value in response to receiving a reporting command.

20. The computer-readable medium of claim 19, wherein the method includes:
providing a reporting graphical user interface including a plurality of selectable indicators of reporting types, the reporting types including an additions report type, a retirements report type, a depreciation report type, an inter-company transfer report type, an intra-company transfer report type, a cost of removal report type, a salvage report type, a right of way report type, a reused material report type, a copper line report type, a fiber line report type, or any combination thereof, and
receiving a selection of an indicator of a reporting type, wherein the adjusted value of the asset is included in the report type.
